(19) United States
(12) Patent Application Publication
(10) Pub. No.: US 2026/0177980 A1
(43) Pub. Date: Jun. 25, 2026

(54) DIAL AND TIMEPIECE

(71) Applicant: CASIO COMPUTER CO., LTD., Tokyo (JP)

(72) Inventors: Ryuma IZUMI, Tokyo (JP); Noriyuki KITTA, Tokyo (JP)

(73) Assignee: CASIO COMPUTER CO., LTD., Tokyo (JP)

(21) Appl. No.: 19/409,898

(22) Filed: Dec. 5, 2025

(30) Foreign Application Priority Data
Dec. 19, 2024 (JP) 2024-223857

(51) Int. Cl. G04B 19/06; G04B 19/10; G04B 19/22

(52) U.S. Cl. CPC G04B 19/065; G04B 19/10; G04B 19/22

(57) ABSTRACT

A dial including: a plurality of first scales each of which is a first scale for indicating a first type of display content; and a plurality of second scales each of which is a second scale for indicating a second type of display content different from the first type. At least some of the plurality of first scales and the plurality of second scales are arranged alternately.

### REFERENCE TO RELATED APPLICATIONS

The entire disclosure of Japanese Patent Application No. 2024-223857 filed on Dec. 19, 2024, including description, claims, drawings and abstract is incorporated herein by reference.

### TECHNICAL FIELD

The present disclosure relates to a dial and a timepiece.

### DESCRIPTION OF RELATED ART

In the past, a timepiece capable of two types of displaying in a single display area by separately arranging two types of scales with different display contents on the left and right sides of the display area (see, for example, JP 2018-109553 A).

### SUMMARY OF THE INVENTION

To achieve at least one of the abovementioned objects, a dial reflecting one aspect of the present disclosure comprises:
a plurality of first scales each of which is a first scale for indicating a first type of display content; and
a plurality of second scales each of which is a second scale for indicating a second type of display content different from the first type,
wherein
at least some of the plurality of first scales and the plurality of second scales are arranged alternately.

### BRIEF DESCRIPTION OF DRAWINGS

FIG. 1 is a plan view of a timepiece according to the present disclosure.

FIG. 2 shows an enlarged view of a first area of a dial in FIG. 1.

FIG. 3 shows how a seconds counting scale lights on halfway through.

FIG. 4 shows how a hand points to a WT mode.

### DETAILED DESCRIPTION

Hereinafter, one or more embodiments of the present disclosure will be described with reference to the drawings. However, the embodiments described below are subject to various technically preferred limitations for implementing the present disclosure. Therefore, the technical scope of the present disclosure is not limited to the following embodiments and illustrative examples.

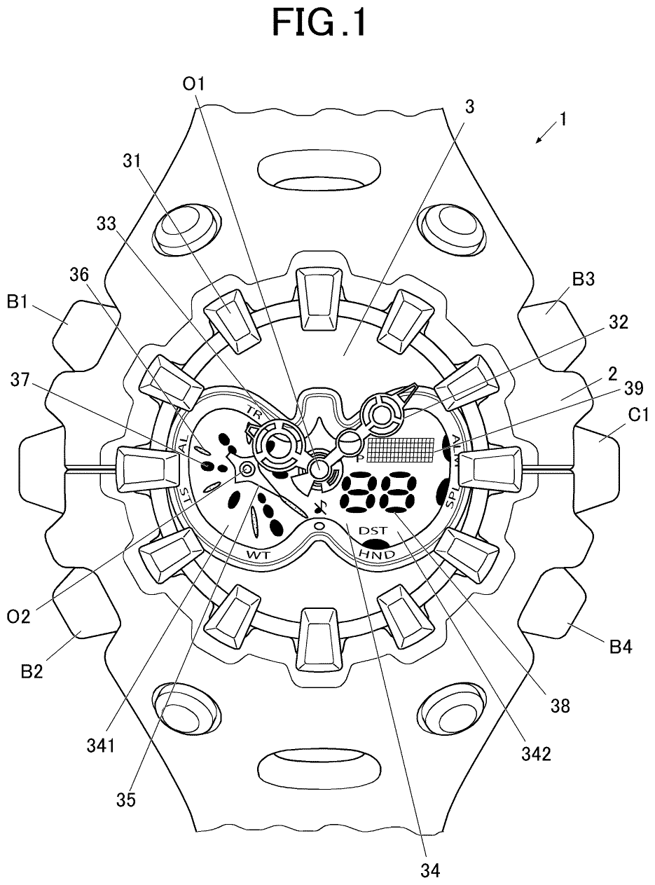

As shown in FIG. 1, a timepiece 1 of the present disclosure is, for example, a wristwatch-type timepiece. The timepiece 1 is equipped with a housing 2, a dial 3, and actuators such as pushbutton switches B1, B2, B3, B4, and a crown C1. The dial 3 is located inside the housing 2, and its upper surface is covered by a transparent windshield glass, which is not shown in the figure. Below the dial 3 inside the housing 2 of the timepiece 1, though not shown in the figure, there are incorporated a board, motors and gears for rotating a minute hand 32 and a hour hand 33 around the hand axis O1, and motors and gears for rotating a hand 35 around the hand axis O2. The bottom of the timepiece 1 is sealed by a back cover, which is not shown.

The board located below the dial 3 contains, for example, a control unit such as a microcontroller, a memory unit (flash memory, etc.) in which programs, etc. are stored, a large capacitor, electronic circuits (oscillator circuit, frequency divider circuit, timekeeping circuit), quartz oscillator, etc. The control unit controls the motors and gears for rotating the minute hand 32 and hour hand 33 based on electrical signals output from the electronic circuit to display the time. The control unit also switches modes according to the operation of pushbutton switches B1 to B4, controls motors and gears to rotate the hand 35 according to the mode to display the mode, makes measurements according to the mode, makes the seconds counting scale 37 count, and makes display control of the seven-segment display 38 and the digital display 39 to be described below.

The dial 3 in this embodiment is circular, and hour characters 31 (index) and scales are arranged along the circumferential direction of the dial 3. The hand axis O1 is located at the center of the dial 3. The minute hand 32 and hour hand 33 rotate around the hand axis O1 to indicate the time by pointing to the hour character 31 or the scale as appropriate.

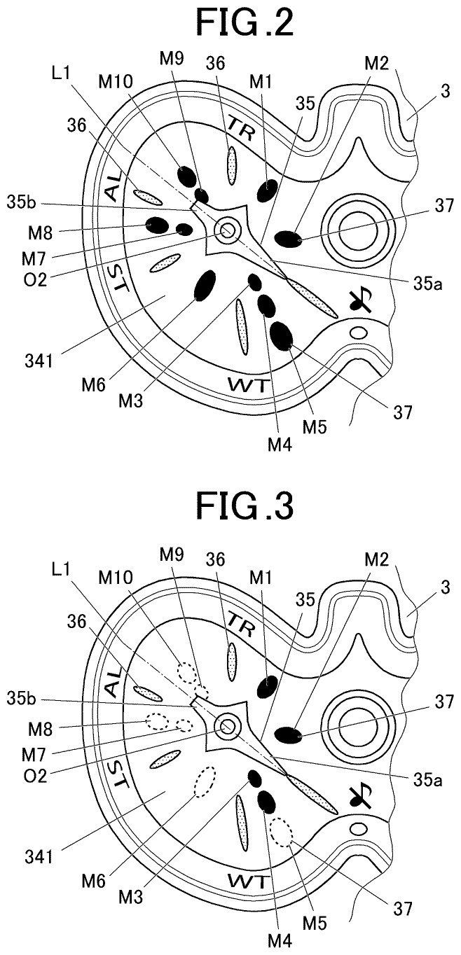

The dial 3 also has a display area 34 for displaying various information. The display area 34 is a digitally displayable display area using, for example, liquid crystal, and is composed of a first area 341 and a second area 342. As shown in FIG. 2, the first area 341 is provided with a hand 35, a mode displaying scale 36 (first scale), and a seconds counting scale 37 (second scale). In FIGS. 2 through 4, the minute hand 32 and hour hand 33 are omitted.

The mode displaying scale 36 is a scale indicating the current mode of the timepiece 1 (first type of display content), indicated by the hand 35, and is printed on the screen of the display area 34. The mode displaying scale 36 consists of a plurality of (five in this case) scales indicating BT (base time) mode, WT (world time) mode, ST (stopwatch) mode, TR (timer) mode, and AL (alarm) mode, respectively. The length of each scale (length of scale mark) of the mode displaying scale 36 is not constant; the more frequently used modes (e.g., BT mode) are longer. Each scale of the mode displaying scale 36 is arranged radially around the hand axis O2, and a character string or symbol representing the mode (BT, WT, ST, TR, AL) indicated by each scale is displayed on the extended line of each scale of the mode displaying scale 36 as viewed from the hand 35. In FIGS. 2 through 4, the BT mode is represented by an ellipse. The hand 35 rotates around the hand axis O2 to display the mode by indicating the scale corresponding to the current mode of the timepiece 1.

The seconds counting scale 37 consists of 10 scales from M1 to M10, which light on or off in increments of 1 second or 0.1 second, starting with M1, to count seconds (time information: the second type of display content). For example, in BT mode, the seconds counting scale 37 lights on in one-second increments, starting with M1, and when the count up to 10 seconds is completed and the light lights on up to M10, the scale repeats the operation of lighting off in one-second increments, starting with M1. In ST mode, for example, the seconds counting scale 37 lights on in 0.1 second increments, starting from M1, and when the count up to 1 second is completed and the scale lights on up to M10, it repeatedly lights off in 0.1 second increments, starting from M1. FIG. 3 shows how M1 through M4 of the seconds counting scale 37 are illuminated. In FIG. 3, the positions of M5 to M10, which are unlit, are indicated by dotted lines, but the dotted lines are not actually displayed.

Here, if the first area 341 were to be divided in half, with scale 36 arranged in one area and seconds counting scale 37 arranged in the other area, the range in which each scale can be arranged would be narrower, resulting in a smaller scale interval. This makes it difficult for the user to see which scale the hand 35 is pointing to, which may lead to misidentification.

Therefore, in this timepiece 1, at least some scales of the mode displaying scale 36 and seconds counting scale 37 are arranged alternately, as shown in FIG. 2. This allows the arrangement interval of the respective scales for mode displaying scale 36 and seconds counting scale 37 to be widened, so that each scale can be displayed legibly and the user can easily recognize which scale the hand 35 is pointing to. If both the mode displaying scale 36 and the seconds counting scale 37 are indicated by the hand 35, it would be difficult to know which scale the hand 35 is pointing to because of the large number of scales. However, in the embodiment, the seconds counting scale 37 is not indicated by the hand 35 and the scales of the seconds counting scale 37 not indicated by the hand 35 are arranged between the plurality of scales of the mode displaying scale 36 indicated by the hand 35, so that the user can easily recognize which scale the hand 35 is pointing to.

As shown in FIG. 2, the color and shape of the mode displaying scale 36 and the seconds counting scale 37 are different. For example, the mode displaying scale 36 is red, the seconds counting scale 37 is the same color as the background of the first area 341 (e.g., white or black) when lighting off and a predetermined color (e.g., black or white) when lighting on. The mode displaying scale 36 is an elongated needle shape, and the seconds counting scale 37 is an oval shape. Thus, by differentiating the appearance of the mode displaying scale 36 and the seconds counting scale 37, the difference between the two can be highlighted and misidentification of the scale by the user can be prevented. The seconds counting scale 37 is not lit when seconds are not counted in ST mode, so it is the same color as the background color. This makes the hand 35 easier to read.

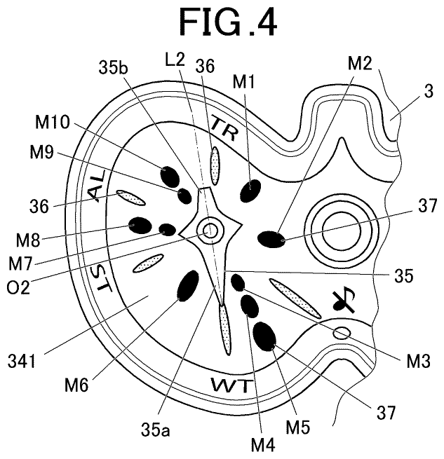

The plurality of scales of the mode displaying scale 36 are arranged in positions that are not symmetrical to each other with respect to the hand axis O2. For example, in FIG. 2, the hand 35 points to the mode displaying scale 36 in the BT mode, but there are no other mode's mode displaying scales 36 or seconds counting scales 37 arranged on the dashed line L1, which indicates a position symmetrical to the mode displaying scale 36 in the BT mode with respect to the hand axis O2. In FIG. 4, the hand 35 points to the mode displaying scale 36 for the WT mode, but there are no other mode's mode displaying scales 36 or seconds counting scales 37 arranged on the dashed line L2, which indicates a position symmetrical to the mode displaying scale 36 for the WT mode with respect to the hand axis O2. This allows the user to easily recognize which scale the hand 35 is pointing to, even when using a hand 35 with ends of about the same length, the ends being a leading end 35a on the leading side and a back end 35b on the back side with respect to the hand axis O2.

If the leading end 35a and the back end 35b of the hand 35 are about the same length, it is difficult to distinguish between the two. Therefore, as shown in FIG. 2, it is preferable that the leading end 35a of the hand 35 is elongated and sharp, while the back end 35b is not sharp. This makes it easier for the user to distinguish between the leading end 35a and back end 35b of the hand 35.

The leading end 35a may be long enough to overlap the mode displaying scale 36, and the back end 35b may be of a length not overlapping the mode displaying scale 36. This allows the user to more reliably determine which scale the hand 35 is pointing to, since the leading end 35a and the mode displaying scale 36 overlap when the hand 35 is pointing to the mode displaying scale 36. It is also easier for the user to determine that the back end 35b does not indicate the scale. It is preferable that scales M1 to M10 of the seconds counting scale 37 are arranged so as at least partially not to overlap with the back end 35b of the hand 35 when the hand 35 is indicating the mode displaying scale 36, so that the seconds counting scale 37 is visible when the hand 35 is indicating any mode.

Returning to FIG. 1, the second area 342 has a seven-segment display 38 that displays numbers in seven-segment format and a digital display 39 that displays letters and numbers. For example, the digital display 39 shows the date and day of the week. In ST mode, the digital display 39 shows the minutes and seconds of the elapsed time since the start of measurement, and the seven-segment display 38 shows the seconds in increments of 0.1 and 0.01 seconds. This allows the user to recognize more accurate measurements.

As explained above, the dial 3 of the timepiece 1 has a plurality of scales of mode displaying scale 36 for indicating the current mode and seconds counting scale 37 for indicating seconds counting, and at least some of scales of the mode displaying scale 36 and seconds counting scales 37 are arranged alternately. In the dials of the conventional technology in which two types of scales are arranged separately on the left and right in one display area, each type of scale must be arranged in a narrower area than when only one type of scale is arranged in one display area, making it difficult for the user to know which scale the hand is pointing to, and thus preventing the user from reading the detailed values. According to the present disclosure, compared to dials of the conventional technology, the arrangement interval of the respective scales for mode displaying scale 36 and seconds counting scale 37 can be widened, so that each scale can be displayed legibly and the user can easily recognize which scale the hand 35 is pointing to.

For example, the mode displaying scale 36 is a scale indicated by the hand 35, and the seconds counting scale 37 is a scale not indicated by the hand 35. In this way, the user can easily recognize which scale the hand 35 is pointing to by having the seconds counting scale 37, which is not indicated by the hand 35, arranged between the plurality of scales of the mode displaying scale 36 indicated by the hand 35.

For example, by using different shapes for the mode displaying scale 36 and the seconds counting scale 37, the user can easily distinguish between the mode displaying scale 36 and the seconds counting scale 37, thus preventing misidentification of the scale by the user.

For example, by making the mode displaying scale 36 and seconds counting scale 37 in different colors, the user can easily distinguish between the mode displaying scale 36 and the seconds counting scale 37, thus preventing misidentification of the scale by the user.

In addition, the plurality of scales of the mode displaying scale 36 are arranged in positions that are not symmetrical to each other with respect to the hand axis O2 (rotation axis) of the hand 35 that indicates the mode displaying scale 36, so that even if a hand 35 with a leading end 35a and a back end 35b of equal length is used, the user can recognize which scale the hand 35 is pointing to with certainty.

The leading end 35a of the hand 35 is sharp and the back end 35b is not sharp, making it easier for the user to distinguish between the leading end 35a and back end 35b of the hand 35.

In addition, each scale of the seconds counting scale 37 is arranged at a position where it does not overlap at least partially with the hand 35 when the hand 35 is indicating the mode displaying scale 36, so that the user can see the seconds counting scale 37 no matter which mode the hand 35 is indicating.

The seconds counting scale 37 indicates the seconds count by lighting on or off, so that the user can recognize what the seconds counting scale 37 indicates even when it is near the hand 35 and the mode displaying scale 36.

The description in the above embodiment is a suitable example of the timepiece 1 of the present disclosure, and the present disclosure is not limited thereto.

For example, in the above embodiment, the first scale is each scale of the mode displaying scale 36 and the second scale is each scale of the seconds counting scale 37, but these are examples and the scales are not limited thereto.

Other detailed configuration and operation of the timepiece 1 can also be changed as needed without departing from the intent of the present disclosure.

Although the embodiments of the present disclosure have been described above, the technical scope of the present disclosure is not limited to the embodiments described above, but is defined based on the claims. Furthermore, the technical scope of the disclosure includes an equal scope with changes from the claims that have nothing to do with the essence of the disclosure.

1. A dial comprising:
a plurality of first scales each of which is a first scale for indicating a first type of display content; and
a plurality of second scales each of which is a second scale for indicating a second type of display content different from the first type,
wherein
at least some of the plurality of first scales and the plurality of second scales are arranged alternately.

2. The dial according to claim 1, wherein
the first scale is a scale indicated by a hand, and
the second scale is a scale that is not indicated by the hand.

3. The dial according to claim 1, wherein
the first scale and the second scale are in different shapes.

4. The dial according to claim 1, wherein
the first scale and the second scale are in different colors.

5. The dial according to claim 2, wherein
the plurality of first scales are arranged at positions that are not symmetrical to each other with respect to a rotation axis of the hand.

6. The dial according to claim 2, wherein
a leading end of the hand is sharp and a back end of the hand is not sharp.

7. The dial according to claim 2, wherein
a leading end of the hand is of a length that overlaps the first scale and a back end of the hand is of a length that does not overlap the first scale.

8. The dial according to claim 2, wherein
the second scale is arranged at a position where the second scale does not overlap at least partially with the hand when the hand is indicating the first scale.

9. The dial according to claim 1, wherein
the second scale indicates the second type of display content by lighting on or off.

10. The dial according to claim 1, wherein
the first type of display content is mode information, and the second type of display content is time information.

11. A timepiece comprising:
the dial according to claim 1, and
a hand.
